(19) United States
(12) Patent Application Publication
(10) Pub. No.: US 2009/0026840 A1
(43) Pub. Date: Jan. 29, 2009

(54) APPARATUS AND METHOD FOR SUPPLYING POWER TO AN INDUCTIVE LOAD

(76) Inventor: Helmut Lenz, Oberasbach (DE)

Correspondence Address: BRINKS HOFER GILSON & LIONE, P.O. BOX 10395, CHICAGO, IL, 60610, US

(21) Appl. No.: 12/135,732

(22) Filed: Jun. 9, 2008

(30) Foreign Application Priority Data
Jun. 12, 2007 (DE) DE 102007026912.0

(51) Int. Cl. H02J 1/00; G05F 1/10

(52) U.S. Cl. 307/63; 307/52; 323/234

(57) ABSTRACT

A power supply for at least one predominantly inductive load is provided. The power supply includes at least one controllable voltage source powered with a supply voltage, the at least one controllable voltage source supplying a controlled output voltage which powers the inductive load. The supply voltage of the voltage source is variable and the supply voltage is operable to be controlled as a function of the current flowing through the predominantly inductive load.

The present patent document claims the benefit of the filing date of DE 10 2007 026 912.0 filed Jun. 12, 2007, which is hereby incorporated by reference.

### BACKGROUND

The present embodiments relate to supplying power to a predominantly inductive load.

Magnetic capsule endoscopy includes navigating a capsule, which is suited to endoscopic examinations and has a video camera, a light, a radio transmitter, and a battery, for example, through the body of a person. For example, the capsule may be navigated through the intestine using an external magnetic field. The patient to be examined is located within an electric coil system. The magnetic fields of the electrical coil system exert forces on a permanent magnet fastened within the capsule. The external magnetic field can move the capsule forward or a magnetic field of rotation can rotate the capsule. DE 101 42 253 C1 describes moving the capsule.

Magnetic capsule endoscopy includes the electric coil system controlling the outer magnetic field and the current flow. Switched power supplies can control the outer magnetic field. The switched power supplies are used in magnetic resonance tomography as gradient amplifiers, for example. DE 198 12 069 A1 discloses gradient amplifiers for gradient coils. If the inductance of the gradient coil of a magnetic resonance tomography is typically 0.5 mH, then an inductance, which is generally larger by one hundred times, is required for gradient coils used in magnetic capsule endoscopy. Voltage changes in the charging capacitors of the output stage of the gradient amplifier of some 100 V are needed in order to store the overall magnetic energy stored in the coil system in the charging capacitors during demagnetization.

Suitable power supplies have controllable voltage sources as output stages. The output stages have a sufficient charging capacitor capacity and reserves of capacitor voltage in order to receive the energy from the inductive load by increasing the capacitor voltage. The voltage is supplied at the output stages by a passive power pack having a constant voltage. The power input from the supply network of a temporally variable magnetic field takes place discontinuously, for example, in pulses, as a result of which an unequal load is placed on the supply network.

### SUMMARY AND DESCRIPTION

The present embodiments may obviate one or more drawbacks or limitations inherent in the related art. For example, in one embodiment, a controllable power supply provides a more equal load on the public power supply network.

In one embodiment, a power supply includes at least one controllable voltage source for at least a predominantly inductive load. The controllable voltage source is fed with a variable power supply, and outputs a controlled output voltage. The power supply of the voltage source may be controlled as a function of the current flowing through the predominantly inductive load.

In one embodiment, a charging capacitor is arranged in parallel to the input of the supply voltage in the voltage source. The supply voltage is controlled such that it equals the present voltage at the charging capacitor of the voltage source.

The load placed on the public mains supply may be uniform.

The state of charge of the charging capacitor may be predetermined and may provide the required coil current.

The power supply may have a direct voltage source providing the power supply and a control unit. the control unit may control the direct voltage source, such that the direct voltage source outputs the desired supply voltage.

The power supply may have several controllable voltage sources which are connected in series.

One or more power supplies may be used in a magnetic capsule endoscopy system and may supply at least one gradient coil with coil current. A magnetic endocapsule may be moved by the magnetic field of the gradient coil.

It is advantageous during use in capsule endoscopy that rotating magnetic fields can be generated to rotate magnetic endocapsules, without having to place an unequal load on the public power supply.

In one embodiment, a method for supplying power to a predominantly inductive load having a supply voltage is provided. The method includes controlling the supply voltage as a function of the current flowing through the predominantly inductive load. The method may include controlling the supply voltage such that the supply voltage is equal to a calculated voltage at a charging capacitor of the power supply. The method may be used to control a magnetic capsule endoscopy system.

### BRIEF DESCRIPTION OF THE DRAWINGS

FIG. 1 is a block diagram of one embodiment of a power supply; and

FIG. 2 illustrates current and voltage curves of the power supply.

### DETAILED DESCRIPTION

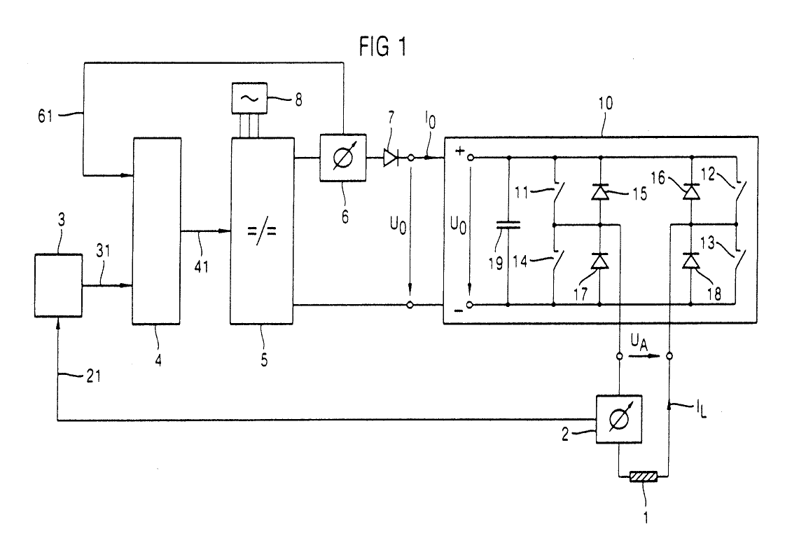

FIG. 1 illustrates a block diagram of a power supply of a predominantly inductive load 1, for example, of a gradient coil for moving a magnetic endoscopic capsule. The power supply includes a controllable voltage source 10, which generates the output voltage U_{A}. The power supply is fed (supplied) by a direct current source 5, which may be a DC/DC converter, with a supply voltage U₀ and a supply current I₀.

The direct voltage source 5 is supplied with a three-phase alternating voltage from a public or mains power supply network 8. The temporally changeable coil current I_{L} flowing through the inductive load 1 is measured by a current measuring device 2. The current measured value 21 may be fed (transmitted) to an evaluation unit 3. In the evaluation unit 3, a voltage target value 31 of the supply voltage U₀ may be determined from the current measured value 21. The voltage target value 31 may be fed to a direct current control unit 4. The value of the supply voltage U₀ may be measured using a voltage measuring device 6. The measured voltage value 61 may be fed to the direct current control unit 4. A control signal 41 is formed in the direct current control unit 4 by comparing the voltage target value 31 with the present voltage value 61. The control signal 41 may control the direct voltage source 5 such that the supply voltage U₀ corresponds to the voltage target value 31.

A diode 7 may be disposed in the conductor path between the direct voltage source 5 and the voltage source 10. The diode 7 may prevent current from flowing out of the voltage source 10 into the direct voltage source 5. The diode 7 may be omitted if current flowing out of the voltage source 10 into the direct voltage source 5 is ruled out by the type of direct voltage source 5, or no negative effects are expected.

The controllable voltage source 10 includes a power bridge circuit 11, . . . , 18. The power bridge circuit may be powered by the controllable supply voltage U₀. A charging capacitor 19 may be provided in the controllable voltage source 10 in parallel with the supply voltage U₀. The charging capacitor 19 has sufficient capacitance C and reserves of capacitor voltage U_{C} to be able to receive the energy from the inductive load 1 by increasing the capacitor voltage U_{C}.

The power bridge circuit 11, . . . , 18 of the controllable voltage source 10 has four switching elements 11, 12, 13, 14. The four switching elements 11, 12, 13, 14 may be npn bipolar transistors, MOSFETs, or IGBTs, for example. The freewheeling diodes 15, 16, 17, 18 may be arranged in parallel to the switching elements 11, 12, 13, 14. The two switching elements 11, 14 and 12, 13 may be connected in series in order to form a bridging circuit between the poles of the supply voltage U₀. The output voltage U_{A} of the voltage source 10 may be tapped off (determined) at the lateral bridge arm. The switching elements 11, 12, 13, 14 may be controlled by a control circuit. The control circuit may provide pulse width modulated control signals for the switching elements 11, 12, 13, 14, for example.

The voltage target value 31 may be derived from the following known electrical variables:

I_{L}(t): the present coil current I_{L} which is dependent on time t;

C: the capacitance of the charging capacitor 19 of the controllable voltage source 10;

L: the inductance of the inductive load 1;

Uₘᵢₙ: the minimum value of the output voltage U_{A}, which covers at least the voltage requirement of the ohmic resistor of the inductive load;

Iₘₐₓ: the predetermined maximum coil current I_{L}; and

U_{C}(t): the voltage at the charging capacitor 19, which is dependent on time t.

In the following equation, the ohmic losses may be intentionally neglected. For example: [½*L*Iₘₐₓ²]−[½*L*I_{L}(t)²]=[½*C*U_{C}(t)²]−[½*C*Uₘᵢₙ²] applies in accordance with energy conservation. In the above equation:

[½*L*Iₘₐₓ²]: is the magnetic field energy of the inductive load 1 with a maximum coil current Iₘₐₓ;

[½*L*I_{L}(t)²]: is the magnetic field energy of the inductive load 1 at time t;

[½*C*U_{C}(t)²]: is the energy of the charging capacitor 19 at time t;

[½*C*Uₘᵢₙ²]: is the energy of the charging capacitor 19 with the minimum output voltage Uₘᵢₙ.

The ideal voltage U_{C}(t) may be determined. Resolved in accordance with the time-dependent voltage at the capacitor, the ideal voltage U_{C}(t) may be:

U_{C}(t)={1/C*[L*Iₘₐₓ²−L*I_{L}(t)²+C*Uₘᵢₙ²]}^{-1/2}

The voltage target value 31 may correspond to the ideal voltage U_{C}(t) at the charging capacitor 19. The supply voltage U₀ may follow the ideal voltage U_{C}(t) at the charging capacitor 19. The direct voltage source 5 may continuously feed the precisely required power loss including switching losses of the voltage source 10. An impulse-like charging of the public power supply network 8 is avoided.

In order to set up temporal sinusoidal magnetic fields of the inductive load 1, the switching elements 11, 12, 13, 14 may be controlled with a suitable pulse width modulation, in order to generate a sinusoidal coil current I_{L}.

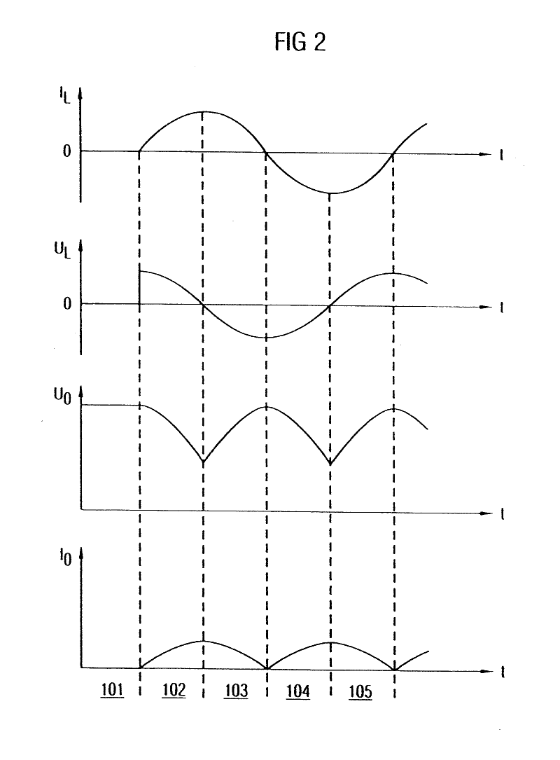

FIG. 2 illustrates one representation of the temporal characteristics of the coil current I_{L}, the coil voltage U_{L}, the supply voltage U₀, and of the supply current I₀.

In section 101, the coil current I_{L} is zero, the coil voltage U_{L} is zero, the supply voltage U₀ is at its maximum value, and the supply current I₀ is almost zero, since only the switching losses of the idling controllable voltage source 10 have to be covered. The charging capacitor 19 may be charged to a maximum prior to section 101.

In section 102, the sinusoidal coil current I_{L} starts. The coil voltage U_{L} jumps to a maximum value as a result of self-inductance and reduces sinusoidally until reaching the peak value Iₘₐₓ of the coil current I_{L}. The supply voltage U₀, approximated in the manner of a cosine function, reduces until reaching a minimum supply voltage, which is identical to the minimum value Uₘᵢₙ of the output voltage U_{A}. The supply current I₀ increases as a sine function until reaching a peak value, which is sufficient to cover the ohmic losses. The overall energy which is needed to set up the magnetic field of the inductive load 1 is taken from the already charged charging capacitor 19.

At the start of section 103, the coil voltage U_{L} is zero and is negative in section 103, since coil current I_{L} is dispelled. The energy stored in the magnetic field of the inductive load 1 is transmitted into the charging capacitor 19 of the controllable voltage source 10, so that the voltage U_{C} at the charging capacitor 19 increases to its maximum value at the end of the region 103. In one embodiment, the supply voltage U₀ follows the voltage U_{C} at the charging capacitor 19. The supply current I₀ reduces until reaching a minimum value covering the losses. At the end of section 103, the coil voltage U_{L} has reached its negative peak value.

At the start of section 104, the coil current I_{L} is negative. The energy is taken from the charged charging capacitor 19, as a result of which the energy is discharged. At the end of region 104, the voltage U_{C} at the charging capacitor 19 and the supply voltage U₀ following it arrive at a minimum value Uₘᵢₙ again. The supply current I₀ may be used from region 104 to cover the ohmic power loss of the inductive load 1 and to cover the switching losses of the controllable voltage source 10.

In section 105, energy is dispelled again from the magnetic field of the inductive load 1, and is transmitted to the charging capacitor 19. The voltage U_{C} at the charging capacitor 19 and the supply voltage U₀ increases again. At the end of section 105, the energy of the magnetic field is located in the charging capacitor 19.

The slew rate limit may prevent the direct voltage source 5 from drawing impermissible power from the public supply network 8 when turning on the power supply, for example. Since the coil current I_{L} is zero, the direct voltage source 5 may attempt to charge the charging capacitor 19 immediately to the maximum value of the supply voltage U₀. By limiting the increase in the supply voltage U₀, the load placed on the public power supply network 8 is limited. Optionally, the current from the public power supply network 8 or the supply current I₀ could also be limited.

The power supply may have several voltage sources 10, which are supplied and controlled by a direct voltage source 5. The voltage sources 10 may be connected in series. The voltage sources 10 may be powered by rectifiers, which at secondary windings of a transformer operated on the primary side by an alternator and are powered in a potential-free fashion. The transformer may be powered by the direct voltage source 5.

To generate a rotating magnetic field in order to rotate an endoscopic magnetic capsule, for example, at least two power supplies are arranged spatially offset from one another with an inductive load 1 in each instance and are powered with sinusoidal coil currents I_{L} having a suitable phase offset.

1. A power supply for at least one predominantly inductive load, the power supply comprising:
at least one controllable voltage source powered with a supply voltage, the at least one controllable voltage source supplying a controlled output voltage which powers the inductive load,
wherein the supply voltage of the voltage source is variable and the supply voltage is operable to be controlled as a function of the current flowing through the predominantly inductive load.

2. The power supply as claimed in claim 1, further comprising a charging capacitor arranged in parallel to the input of the supply voltage in the voltage source, wherein energy of the charging capacitor is operable to be changed as a function of the current flowing through the predominantly inductive load.

3. The power supply as claimed in claim 1, further comprising a direct voltage source providing the supply voltage, a control unit, and an evaluation unit, wherein the control unit is operable to control the direct voltage source based on a default value of the evaluation unit which is determined from the current flowing through the predominantly inductive load.

4. The power supply as claimed in claim 3, wherein the evaluation unit calculates a voltage target value of the control unit from the current flowing through the predominantly inductive load, such that the momentary power loading of the direct voltage source corresponds essentially to an active power portion formed in the ohmic loss of the inductive load and the momentary switching losses of the voltage source.

5. The power supply as claimed in claim 4, wherein the evaluation unit calculates a voltage target value of the control unit from the current flowing through the predominantly inductive load, such that a magnetic energy of the inductive load is supplied from the charging capacitor or is fed back into the charging capacitor without essential portions of this reactive power being provided by the direct voltage source.

6. The power supply as claimed in claim 1, comprising two or more controllable voltage sources connected in series.

7. A magnetic capsule endoscopy system comprising:
a magnetic endocapsule;
a gradient coil that is operable to generate a magnetic field to move the magnetic endocapsule;
a power supply that supplies the gradient coil with a coil current, the supply voltage of the power supply is variable and the supply voltage is operable to be controlled as a function of a current flowing through the gradient coil,
wherein a magnetic endocapsule is operable to be moved by the magnetic field of the gradient coil.

8. A method for supplying power to a predominantly inductive load having a supply voltage, the method comprising:
controlling the supply voltage as a function of the current flowing through the pre-dominantly inductive load.

9. A method as claimed in claim 8, wherein controlling the supply voltage includes controlling the supply voltage such that the supply voltage is equal to a calculated voltage at a charging capacitor of the power supply.

10. The method as claimed in claim 8, wherein controlling the supply voltage includes controlling a gradient coil of a magnetic capsule endoscopy system.

11. The magnetic capsule endoscopy system as claimed in claim 7, wherein the power supply includes a charging capacitor arranged in parallel to a supply voltage in the voltage source, wherein energy of the charging capacitor is operable to be changed as a function of the current flowing through the predominantly inductive load.

12. The magnetic capsule endoscopy system as claimed in claim 7, comprising a direct voltage source that is operable to provide the supply voltage; a control unit; and an evaluation unit, wherein the control unit is operable to control the direct voltage source based on a default value of the evaluation unit which is determined from the current flowing through the predominantly inductive load.

13. The magnetic capsule endoscopy system as claimed in claim 12, wherein the evaluation unit calculates a voltage target value of the control unit from the current flowing through the predominantly inductive load, such that a power loading of the direct voltage source corresponds to an active power portion formed in the ohmic loss of the inductive load and a momentary switching losses of the voltage source.

14. The magnetic capsule endoscopy system as claimed in claim 13, wherein the evaluation unit calculates a voltage target value of the control unit from the current flowing through the predominantly inductive load, such that a magnetic energy of the inductive load is supplied from the charging capacitor or is fed back into the charging capacitor without essential portions of this reactive power being provided by the direct voltage source.

15. The magnetic capsule endoscopy system as claimed in claim 7, comprising two or more controllable voltage sources connected in series.
